(19) United States
(12) Patent Application Publication
(10) Pub. No.: US 2022/0083314 A1
(43) Pub. Date: Mar. 17, 2022

(54) FLEXIBLE ACCELERATOR FOR A TENSOR WORKLOAD

(71) Applicant: NVIDIA Corporation, Santa Clara, CA (US)

(72) Inventors: Po An Tsai, Cambridge, MA (US); Neal Crago, Amherst, MA (US); Angshuman Parashar, Northborough, MA (US); Joel Springer Emer, Acton, MA (US); Stephen William Keckler, Austin, TX (US)

(21) Appl. No.: 17/343,597

(22) Filed: Jun. 9, 2021

Related U.S. Application Data
(60) Provisional application No. 63/078,793, filed on Sep. 15, 2020.

(51) Int. Cl. G06F 7/523; G06F 9/50; G06N 3/02

(52) U.S. Cl. CPC G06F 7/5235; G06N 3/02; G06F 9/505

(57) ABSTRACT

Accelerators are generally utilized to provide high performance and energy efficiency for tensor algorithms. Currently, an accelerator will be specifically designed around the fundamental properties of the tensor algorithm and shape it supports, and thus will exhibit sub-optimal performance when used for other tensor algorithms and shapes. The present disclosure provides a flexible accelerator for tensor workloads. The flexible accelerator can be a flexible tensor accelerator or a FPGA having a dynamically configurable inter-PE network supporting different tensor shapes and different tensor algorithms including at least a GEMM algorithm, a 2D CNN algorithm, and a 3D CNN algorithm, and/or having a flexible DPU in which a dot product length of its dot product sub-units is configurable based on a target compute throughput that is less than or equal to a maximum throughput of the flexible DPU.

### RELATED APPLICATIONS

The present application claims priority to U.S. Provisional Application No. 63/078,793, entitled “MATH ACCELERATOR WITH A FLEXIBLE NETWORK FOR DIVERSE GEMM AND CNN KERNELS,” and filed Sep. 15, 2020, the entire contents of which is incorporated herein by reference.

### GOVERNMENT SUPPORT CLAUSE

This invention was made with US Government support under Agreement HR0011-18-3-0007 (SDH Symphony), awarded by DARPA. The US Government has certain rights in the invention.

### TECHNICAL FIELD

The present disclosure relates to accelerators for tensor workloads.

### BACKGROUND

Accelerator architectures continue to grow as a popular solution to provide high performance and energy efficiency for a fixed set of algorithms. Tensor accelerators in particular have become an essential unit in many platforms, from servers, to mobile devices. One of the key drivers of the adoption of these tensor accelerators has been the rapid deployment of neural network algorithms. At their core, tensor accelerators are designed to natively support one of the two most popular tensor algorithms, general matrix multiplication (GEMM), or convolution (CONV). More specifically, each tensor accelerator is designed around the fundamental properties of a particular algorithm it supports. For example, an input data shape and dataflow mapping of the algorithm to the hardware is codesigned with the hardware in order to tailor the tensor accelerator design to the targeted GEMM or CONV workload.

As a result, this fixed nature of the tensor accelerator limits the effectiveness of the accelerator when algorithms with non-native input data shapes and/or dataflow mappings are run. For example, executing a CONV workload on a GEMM accelerator requires the Toeplitz data layout transformation, which can replicate data and cause unnecessary data movement. As another example, when the workload dimensions do not match well with the tensor accelerator hardware dimensions, the accelerator will suffer from low-utilization.

There is a need for addressing these issues and/or other issues associated with the prior art.

### SUMMARY

A method, computer readable medium, and system are disclosed for a flexible accelerator for tensor workloads. In one embodiment, a flexible tensor accelerator or a flexible field-programmable gate array (FPGA) comprises a dynamically configurable inter-PE network, where the inter-PE network supports configurations for a plurality of different data movements to enable the flexible tensor accelerator/FPGA to be adapted to any one of a plurality of different tensor shapes and any one of a plurality of different tensor algorithms, the plurality of different tensor algorithms including at least a General matrix multiply (GEMM) algorithm, a two-dimensional (2D) convolutional neural network (CNN) algorithm, and a 3D CNN algorithm.

In another embodiment, a flexible tensor accelerator or a flexible FPGA comprises one or more tensor accelerator/FPGA elements that are dynamically configurable to support one or more properties of a tensor workload, the one or more tensor accelerator/FPGA elements including at least a flexible dot product unit (DPU) having configurable logical groupings of dot product sub-units and corresponding sub-accumulators, where a dot product length of each of the dot product sub-units is configurable based on a compute throughput for the flexible DPU.

### BRIEF DESCRIPTION OF THE DRAWINGS

FIG. 1A illustrates a method for configuring a flexible tensor accelerator, in accordance with an embodiment.

FIG. 1B illustrates a method for configuring a flexible tensor accelerator, in accordance with an embodiment.

FIG. 2 illustrates a tensor accelerator architecture, in accordance with an embodiment.

FIG. 3 illustrates a hierarchical tensor accelerator architecture, in accordance with an embodiment.

FIG. 4A illustrates a configurable datapath element including a flexible dot product unit (DPU) with configurable dot product length, in accordance with an embodiment.

FIG. 4B illustrates a configurable processing element (PE) with buffers and DPUs connected via a flexible network, in accordance with an embodiment.

FIG. 4C illustrates a configurable inter-PE network including a double folded torus network topology connecting PEs, in accordance with an embodiment.

FIGS. 5A-C illustrate various dataflows supported by the flexible tensor accelerator, in accordance with an embodiment.

FIGS. 6A-B illustrate various configurations of a flexible tensor accelerator to form a GEMM, in accordance with an embodiment.

FIG. 7A-C illustrate various configurations of a flexible tensor accelerator to form a CONV, in accordance with an embodiment.

FIG. 8 illustrates an exemplary computer system, in accordance with an embodiment.

### DETAILED DESCRIPTION

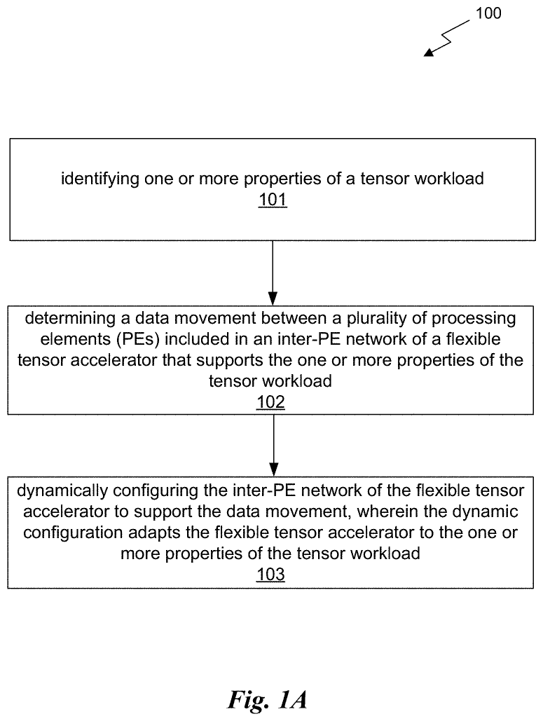

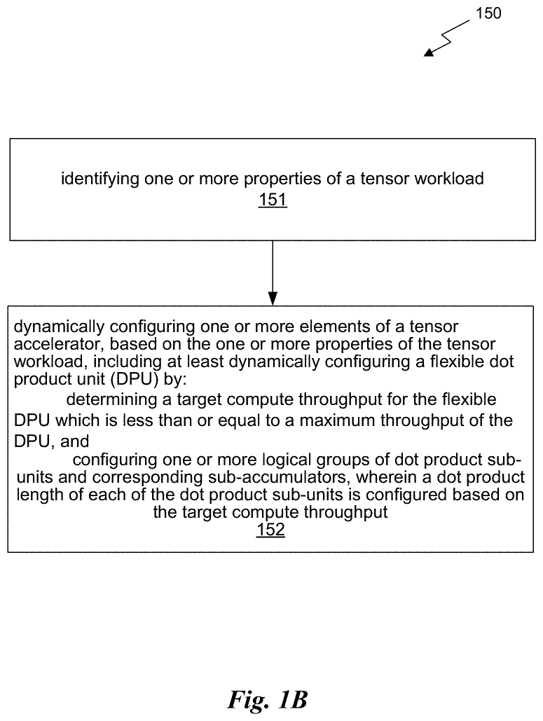

FIG. 1A illustrates a method 100 for configuring a flexible tensor accelerator, in accordance with an embodiment. The method 100 may be performed by a device, for example that includes a hardware processor, to dynamically configure the tensor accelerator for a particular tensor workload, and thus the tensor accelerator may be flexible in that it may be configured specifically for any tensor workload. The hardware processor may be a general-purpose processor (e.g. central processing unit [CPU], graphics processing unit (GPU), etc.] which may or may not be included in the same platform as the flexible tensor accelerator. Of course, it should be noted that the method 100 may be performed using any computer hardware, including any combination of the hardware processor, computer code stored on a non-transitory media (e.g. computer memory), and/or custom circuitry (e.g. a domain-specific, specialized accelerator).

Additionally, the method 100 may be performed in the cloud, optionally where the flexible tensor accelerator also operates in the cloud to improve performance of a workload of a local or remote tensor algorithm. Accordingly, numerous instances of the configured flexible tensor accelerator may exist in the cloud for multiple different tensor workloads. As another option, an instance of the flexible tensor accelerator that is configured based on the property(ies) of a particular tensor workload may be used by other tensor workloads having the same property(ies) as the particular tensor workload.

In the context of the present method 100, or optionally independent of the present method 100, the flexible tensor accelerator includes at least an inter-PE network of processing elements (PEs) which supports configurations for a plurality of different data movements. This support enables the flexible tensor accelerator to be adapted to any one of a plurality of different tensor shapes and any one of a plurality of different tensor algorithms. In this context, the plurality of different tensor algorithms include at least a GEMM algorithm, a two-dimensional (2D) CNN algorithm, and a three-dimensional (3D) CNN algorithm. In various embodiments, as described below, the flexible tensor accelerator may be implemented with a single instruction, multiple data (SIMD) execution engine or an ADX (Multi-Precision Add-Carry Instruction Extensions) instruction. As also described in various embodiments below, the flexible tensor accelerator may include additional configurable elements, such as configurable datapath elements.

In operation 101 of the method 100, one or more properties of a tensor workload are identified. The tensor workload may be any workload (e.g. task, operation, computation, etc.) that relies on a tensor-type data structure, including one-dimensional (1D) tensors (e.g. vectors), two-dimensional (2D) tensors (e.g. matrices), three-dimensional (3D) tensors, etc. In one embodiment, the tensor workload may be a workload executed by a particular tensor algorithm. In this case, the properties of the tensor workload may include the particular tensor algorithm that executes the tensor workload. For example, the tensor algorithm may be part of a machine learning application which uses the tensor-type data structure for the training and operation of a neural network model. In this example, the tensor workload may include the training of a neural network model and/or the operation (inference) of the neural network model. In one embodiment, the tensor algorithm is a convolutional neural network (CNN) algorithm (e.g. 1D CNN algorithm, 2D CNN algorithm, 3D CNN algorithm, etc.). In another embodiment, the tensor algorithm may be a General Matrix Multiply (GEMM) algorithm. Other types of tensor algorithms are also contemplated, such as a stencil computation or a tensor contraction.

Still yet, the one or more properties of the tensor workload may include a dataflow of the tensor workload, such as a type of dataflow of the tensor workload. The type of dataflow may be a store-and-forward multicast/reduction workflow, a skewed multicast/reduction workflow, or a sliding window reuse workflow. The properties of the tensor workflow may include the particular tensor algorithm that executes the tensor workload, in one embodiment. In another embodiment, the properties may include a shape of an input and output of the workload, such as a tile shape and size used by the workload.

The one or more properties of the tensor workload may be identified without user input (i.e. automatically) by analyzing the tensor workload (or the tensor algorithm), in one embodiment. For example, a structure, flow, and/or parameters of the tensor workload may be analyzed to identify (e.g. determine) the one or more properties of the tensor workload. In another embodiment, the one or more properties of the tensor workload may be identified by receiving an indication of the one or more properties (e.g. in the form of metadata, an input stream, etc.). For example, a request to configure the flexible tensor accelerator for the tensor workload (or the tensor algorithm) may include the indication of the one or more properties of the tensor workload, which may be input by a user when submitting the request or may be determined automatically by a separate system.

In operation 102, a data movement between the plurality of PEs included in the inter-PE network of the flexible tensor accelerator is determined, where the data movement supports the one or more properties of the tensor workload (e.g. most efficiently). In embodiment, the data movement may be toroidal.

Of course, a configuration for other elements of the tensor accelerator may also be determined, where the configuration(s) further support the one or more properties of the tensor workload. In one embodiment, the tensor accelerator may include a plurality of hierarchical layers. Further to this embodiment, the other elements of the tensor accelerator for which a configuration is determined, as noted above, may be included in one or more of the hierarchical layers. For example, the one or more elements of the tensor accelerator may include buffers, communication channels, and/or datapath element connections.

Accordingly, in one embodiment, the one or more elements of the tensor accelerator may include datapath elements of the tensor accelerator having one or more functional units. For example, the datapath elements may include at least one dot product unit (DPU), which may have a configurable dot product length as described in more detail with reference to FIG. 1B below. The datapath elements may be included in a datapath layer of the plurality of hierarchical layers of the tensor accelerator. As an example, a configuration for the datapath elements may be based on the one or more properties of the tensor workload whereby the configuration of the datapath elements to support a particular map and reduce operation type and a particular reduction operation size.

In some exemplary embodiments, the configurable datapath elements include a single instruction, multiple data (SIMD) engine or an ADX (Multi-Precision Add-Carry Instruction Extensions) instruction.

In another embodiment, the one or more elements of the tensor accelerator may include the PEs of the tensor accelerator. The PEs of the tensor accelerator may have buffers and datapath element connections between datapath elements of the tensor accelerator. The PEs may be included in a data supply layer of a plurality of hierarchical layers of the tensor accelerator. As an example, a configuration of the buffers and datapath element connections may be determined based on the one or more properties of the tensor workload by configuring the buffers and datapath element connections to enable data reuse.

As noted above, the tensor accelerator includes a configurable inter-PE network that provides connections between processing elements and the global buffer of the tensor accelerator. The inter-PE network may be included in an inter-PE network layer of a plurality of hierarchical layers of the tensor accelerator. A configuration of the global buffer and processing element connections may be determined based on the one or more properties of the tensor workload whereby the configuration of the global buffer and processing element connections supports the one or more properties of the tensor workload.

In one embodiment, the data movement (and optionally other element configurations) may be determined at runtime. In another embodiment, the data movement (and optionally other element configurations) may be determined offline, in advance of the tensor algorithm executing with actual provided input. As yet another option, the data movement and optionally other configuration data (e.g. in a file) may be generated for the tensor accelerator (e.g. in real-time or offline) based on the one or more properties of the tensor workload, for use in dynamically configuring the accelerator (e.g. in real-time or offline).

In operation 103, the inter-PE network of the flexible tensor accelerator is dynamically configured to support the data movement, where the dynamic configuration adapts the flexible tensor accelerator to the one or more properties of the tensor workload. Similarly, other elements of the tensor accelerator may also be dynamically configured, based on the configuration determined for those elements as described above. The term “dynamic” in the present context refers to a change being made to the configuration of the tensor accelerator in a manner that is based on the one or more properties of the tensor workload. As an option, the one or more elements of the tensor accelerator may be dynamically configured at runtime. As another option, the one or more elements of the tensor accelerator may be dynamically configured offline, in advance of the tensor algorithm executing with actual provided input. As yet another option, the tensor accelerator may be dynamically configured (e.g. in real-time or offline) according to the configuration data mentioned above. To this end, the tensor accelerator may be a flexible architecture, in that at least the data movement between the plurality of PEs included in the inter-PE network of the tensor accelerator is capable of being configured according to the one or more properties of the tensor workload.

Accordingly, the method 100 may dynamically configure one or more select elements of the tensor accelerator in accordance with one or more select properties of the tensor workload. This method 100 may accordingly configure a tensor accelerator that is adapted to the particular tensor workload.

It should be noted that while the method 100 is described in the context of a tensor accelerator, other embodiments are contemplated in which the method 100 can similarly be applied to other types of accelerators implemented in hardware. Thus, any of the embodiments described herein may similarly apply to other types of hardware-based accelerators.

To this end, in one embodiment, the method 100 may be performed in the context of a flexible field-programmable gate array (FPGA) instead of a tensor accelerator. In general, FPGAs may include fixed function hardware blocks in addition to the basic Look-Up Tables (LUTs) and Block Random Access Memories (BRAMs). These hardware blocks can include hard-wired logic units that target a tensor algorithm (also referred to as tensor hardware blocks), such as a dot-product unit which takes two vectors and produces an output. The method 100 may be applied to configure a flexible FPGA.

Similar to the flexible tensor accelerator, the flexible FPGA includes at least an inter-PE network of PEs which supports configurations for a plurality of different data movements. This support enables the flexible FPGA to be adapted to any one of a plurality of different tensor shapes and any one of a plurality of different tensor algorithms. In this context, the plurality of different tensor algorithms include at least a GEMM algorithm, a two-dimensional 2D CNN algorithm, and a 3D CNN algorithm.

Also similar to the flexible tensor accelerator, the flexible FPGA may be configured by identifying the one or more properties of the tensor workload (see operation 101), determining a data movement between the plurality of PEs included in the inter-PE network of the flexible tensor accelerator, where the data movement supports the one or more properties of the tensor workload (see operation 102), and dynamically configuring the inter-PE network of the flexible tensor accelerator to support the data movement, where the dynamic configuration adapts the flexible FPGA to the one or more properties of the tensor workload (see operation 103).

FIG. 1B illustrates a method 150 for configuring a flexible tensor accelerator, in accordance with an embodiment. The method 150 may be performed in combination with, or independently of, method 100 of FIG. 1A. In any case, the definitions provided above for method 100 may equally apply to the description of method 150.

The method 150 may be performed by a device, for example that includes a hardware processor, to dynamically configure the tensor accelerator for a particular tensor workload, and thus the tensor accelerator may be flexible in that it may be configured specifically for any tensor workload. The hardware processor may be a general-purpose processor (e.g. central processing unit [CPU], graphics processing unit (GPU), etc.] which may or may not be included in the same platform as the flexible tensor accelerator. Of course, it should be noted that the method 150 may be performed using any computer hardware, including any combination of the hardware processor, computer code stored on a non-transitory media (e.g. computer memory), and/or custom circuitry (e.g. a domain-specific, specialized accelerator).

Additionally, the method 150 may be performed in the cloud, optionally where the flexible tensor accelerator also operates in the cloud to improve performance of a workload of a local or remote tensor algorithm. Accordingly, numerous instances of the configured flexible tensor accelerator may exist in the cloud for multiple different tensor workloads. As another option, an instance of the flexible tensor accelerator that is configured based on the property(ies) of a particular tensor workload may be used by other tensor workloads having the same property(ies) as the particular tensor workload.

In the context of the present method 150, or optionally independent of the present method 150, the flexible tensor accelerator includes at least a flexible DPU. In yet another embodiment, the flexible DPU may be implemented independent even of the flexible tensor accelerator (e.g. the flexible DPU may be used for other purposes).

The flexible DPU may support multiple different targeted compute throughputs (e.g. that are smaller than or equal to the maximal throughput determined at the design time). In particular, the flexible DPU includes at least configurable logical groupings of dot product sub-units and corresponding sub-accumulators, where a dot product length of each of the dot product sub-units is configurable based on a determined compute throughput. In an embodiment, each logical group of the one or more logical groups may include a dot product sub-unit and a corresponding sub-accumulator. In another embodiment, the dot product length of each of the dot product sub-units, when combined, may achieve the determined compute throughput. In yet another embodiment, these dot product sub-units may be configured with a same dot product length.

The support of multiple different targeted compute throughputs enables the flexible tensor accelerator to be adapted to any one of a plurality of different tensor shapes and accordingly any one of a plurality of different tensor workloads. As described in various embodiments below, the flexible tensor accelerator may also include additional configurable elements, such as configurable datapath elements, processing elements, and/or a configurable inter-PE network. In various embodiments, as described below, the flexible tensor accelerator may be implemented with a single instruction, multiple data (SIMD) execution engine or an ADX (Multi-Precision Add-Carry Instruction Extensions) instruction.

In operation 151 of the method 150, one or more properties of a tensor workload are identified. The tensor workload may be any workload (e.g. task, operation, computation, etc.) that relies on a tensor-type data structure, including one-dimensional (1D) tensors (e.g. vectors), two-dimensional (2D) tensors (e.g. matrices), three-dimensional (3D) tensors, etc. In one embodiment, the tensor workload may be a workload executed by a particular tensor algorithm. In this case, the properties of the tensor workload may include the particular tensor algorithm that executes the tensor workload. For example, the tensor algorithm may be part of a machine learning application which uses the tensor-type data structure for the training and operation of a neural network model. In this example, the tensor workload may include the training of a neural network model and/or the operation of the neural network model. In one embodiment, the tensor algorithm is a CNN algorithm (e.g. 1D CNN algorithm, 2D CNN algorithm, 3D CNN algorithm, etc.). In another embodiment, the tensor algorithm may be a GEMM algorithm. Other types of tensor algorithms are also contemplated, such as a stencil computation or a tensor contraction.

Still yet, the one or more properties of the tensor workload may include a dataflow of the tensor workload, such as a type of dataflow of the tensor workload. The type of dataflow may be a store-and-forward multicast/reduction workflow, a skewed multicast/reduction workflow, or a sliding window reuse workflow. The properties of the tensor workflow may include the particular tensor algorithm that executes the tensor workload, in one embodiment. In another embodiment, the properties may include a shape of an input and output of the workload, such as a tile shape and size used by the workload.

In operation 152, one or more elements of the tensor accelerator are dynamically configured, based on the one or more properties of the tensor workload, including at least dynamically configuring a flexible DPU. In the present operation, the flexible DPU is dynamically configured by determining a target compute throughput for the flexible DPU which is less than or equal to a maximum throughput of the flexible DPU, and configuring one or more logical groups of dot product sub-units and corresponding sub-accumulators, where a dot product length of each of the dot product sub-units is configured based on the target compute throughput.

The target compute throughput may be determined based on the one or more properties of the tensor workload, such as a shape of an input and an output of the tensor workload. As noted above, each logical group may include a dot product sub-unit and a corresponding sub-accumulator. In this case, the dot product length of each of the dot product sub-units may be dynamically configured such that, when combined, they achieve the target compute throughput, which is smaller than or equal to the maximum possible throughput. Optionally, these dot product sub-units may be dynamically configured to have a same dot product length.

Of course, other elements of the tensor accelerator may also be dynamically configured based on determined configurations for the elements, where the configuration(s) further support the one or more properties of the tensor workload. In one embodiment, the tensor accelerator may include a plurality of hierarchical layers. Further to this embodiment, the other elements of the tensor accelerator which are dynamically configured, as noted above, may be included in one or more of the hierarchical layers. For example, the one or more elements of the tensor accelerator may include buffers, communication channels, and/or datapath element connections.

Accordingly, in one embodiment, the one or more elements of the tensor accelerator may include datapath elements of the tensor accelerator having one or more functional units. For example, the datapath elements may include at least one dot product unit (DPU) with configurable dot product length. The datapath elements may be included in a datapath layer of the plurality of hierarchical layers of the tensor accelerator. As an example, a configuration for the datapath elements may be based on the one or more properties of the tensor workload whereby the configuration of the datapath elements to support a particular map and reduce operation type and a particular reduction operation size.

In some exemplary embodiments, the configurable datapath elements include a single instruction, multiple data (SIMD) engine or an ADX (Multi-Precision Add-Carry Instruction Extensions) instruction.

In another embodiment, the one or more elements of the tensor accelerator may include the PEs of the tensor accelerator. The PEs of the tensor accelerator may have buffers and datapath element connections between datapath elements of the tensor accelerator. The PEs may be included in a data supply layer of a plurality of hierarchical layers of the tensor accelerator. As an example, a configuration of the buffers and datapath element connections may be determined based on the one or more properties of the tensor workload by configuring the buffers and datapath element connections to enable data reuse.

In yet another embodiment, the one or more elements of the tensor accelerator may include an inter-PE network of the tensor accelerator that connects the global buffer and processing elements of the tensor accelerator. The inter-PE network may be included in an inter-PE network layer of a plurality of hierarchical layers of the tensor accelerator. For example, a configuration of the global buffer and processing element connections may be determined based on the one or more properties of the tensor workload whereby the configuration of the global buffer and processing element connections supports the one or more properties of the tensor workload.

In one embodiment, the element(s) of the tensor accelerator may be dynamically configured at runtime. In another embodiment, the element(s) may be dynamically configured offline, in advance of the tensor algorithm executing with actual provided input. As yet another option, configuration data (e.g. in a file) may be generated for the tensor accelerator (e.g. in real-time or offline) based on the one or more properties of the tensor workload, for use in dynamically configuring the tensor accelerator (e.g. in real-time or offline). To this end, the tensor accelerator may be a flexible architecture, in that at least a flexible DPU may be configured to support a target compute throughput.

Accordingly, the method 150 may dynamically configure one or more select elements of the tensor accelerator in accordance with one or more select properties of the tensor workload. This method 150 may accordingly configure a tensor accelerator that is adapted to the particular tensor workload.

It should be noted that while the method 150 is described in the context of a tensor accelerator, other embodiments are contemplated in which the method 150 can similarly be applied to other types of accelerators implemented in hardware. Thus, any of the embodiments described herein may similarly apply to other types of hardware-based accelerators.

To this end, in one embodiment, the method 150 may be performed in the context of a flexible field-programmable gate array (FPGA) instead of a tensor accelerator. The method 100 may be applied to configure a flexible FPGA.

Similar to the flexible tensor accelerator, the flexible FPGA includes at least a flexible DPU that supports multiple different targeted compute throughputs via configurable logical groupings of dot product sub-units and corresponding sub-accumulators, where a dot product length of each of the dot product sub-units is configurable based on a determined target compute throughput. The support of multiple different targeted compute throughputs enables the flexible FPGA to be adapted to any one of a plurality of different tensor shapes and accordingly any one of a plurality of different tensor workloads.

Also similar to the flexible tensor accelerator, the flexible FPGA may be configured by identifying the one or more properties of the tensor workload (see operation 151), and dynamically configuring one or more elements of the tensor accelerator, based on the one or more properties of the tensor workload, including at least dynamically configuring the flexible DPU by determining a target compute throughput for the flexible DPU and configuring one or more logical groups of dot product sub-units and corresponding sub-accumulators, where a dot product length of each of the dot product sub-units is configured based on the target compute throughput (see operation 152).

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

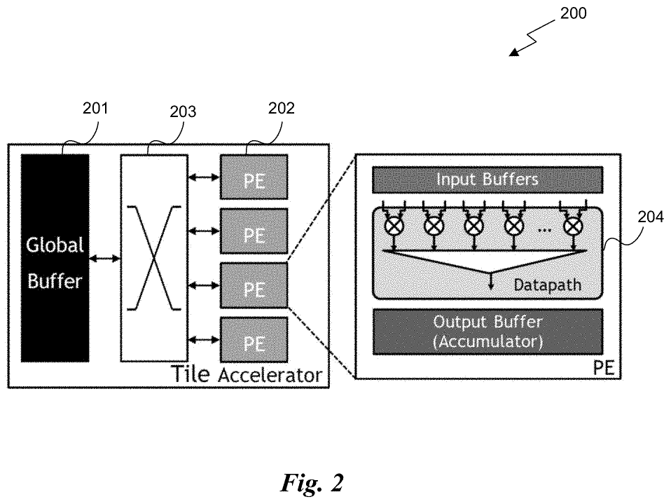

FIG. 2 illustrates a flexible tensor accelerator architecture 200, in accordance with an embodiment. The flexibility of the tensor accelerator architecture 200 may be realized by virtue of the ability to configure the tensor accelerator architecture 200 for a particular workload of a particular (target) tensor algorithm. For example, the tensor accelerator architecture 200 may be configured according to the method 100 of FIG. 1.

As shown, architecture 200 consists of multiple elements, including a global buffer 201, a number of PEs 202, and an on-chip network 203 (i.e. an inter-PE network). The global buffer 201 is a large on-chip buffer designed to exploit data locality and amplify off-chip memory bandwidth. The PE 202 is the core computation element that buffers the inputs, uses a datapath 204 to perform the tensor operation, and stores the result in an accumulator buffer. The on-chip network 203 connects the PEs 202 and the global buffer 201 together and is specialized to the connectivity needs of the tensor algorithm.

Tensor accelerators are often designed for tiled computation, where the input and output datasets are partitioned into smaller pieces, such that those pieces fit well into the memory hierarchy. Tiles are often split or shared across PEs 202 in an accelerator to leverage data reuse. Global memory initially provides the tiles to the PEs 202, which can then exchange tiles with one another using the on-chip network 203.

As noted above, the tensor accelerator architecture 200 may be configured for a particular workload of a particular tensor algorithm. This may be achieved by dynamically configuring one or more of the above mentioned elements of the tensor accelerator in accordance with one or more features of the workflow of the tensor algorithm. In general, the workflow will have features such as a tile shape and dataflow. The tile shape refers to the dimensions of the input and output data tiles used in the workflow computation, which may be regular (e.g. square dimensions) to balance memory capacity, bandwidth, and reuse of tile data. The dataflow refers to the schedule of where the tile data resides in hardware and how that data should be used for computation at a given point in program execution.

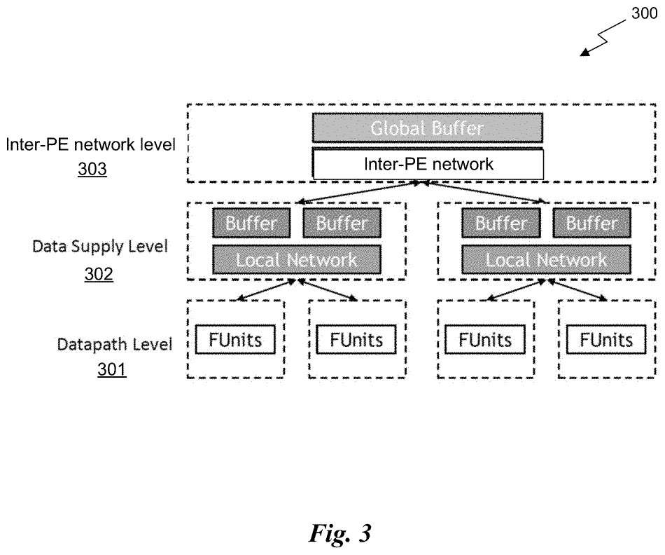

FIG. 3 illustrates a hierarchical tensor accelerator architecture 300, in accordance with an embodiment. The hierarchical tensor accelerator architecture 300 may be implemented in the context of the flexible tensor accelerator architecture 200 of FIG. 2. In particular, the elements of the flexible tensor accelerator architecture 200 of FIG. 2 may be arranged in a plurality of hierarchical layers, as described herein.

Instead of integrating a generalized all-to-all network, flexibility can be provided by segmenting the tensor accelerator design into a multi-level hierarchy. Each level (i.e. layer) in the hierarchy handles a specific task and each, or any select subset, of the levels may be designed to target a small range of activities relevant to the algorithmic domain (i.e. the target tensor algorithm). The levels of the hierarchy combine to create a highly flexible domain-specific accelerator. Each task dimension may have a simplified design space for adding flexibility, based on the targeted set of algorithms.

In the present embodiment, as shown, the tensor accelerator architecture 300 is split into three layers each representing a fundamental design element: datapath 301, data supply 302 (local buffers and network), and on-chip network 303 (i.e. inter-PE network). The datapath 301 elements implement the core operations needed for the accelerator, where flexibility can be added to functional units to increase the range of algorithms. The data supply 302 elements implement PEs and consist of local buffers and connections to the datapath 301 elements, with flexibility in the buffers and connections enabling data reuse. The on-chip network 303 element connects the PEs with one another and to the global buffer where increased yet tailored connectivity can enable multiple dataflows and tile shapes with low hardware cost.

Each level of the hierarchy can be configured at runtime to support multiple operating modes. Altogether, this flexible, hierarchical tensor accelerator architecture 300 targets a much broader set of algorithms than fixed tiled accelerators, without the need for expensive generalized hardware.

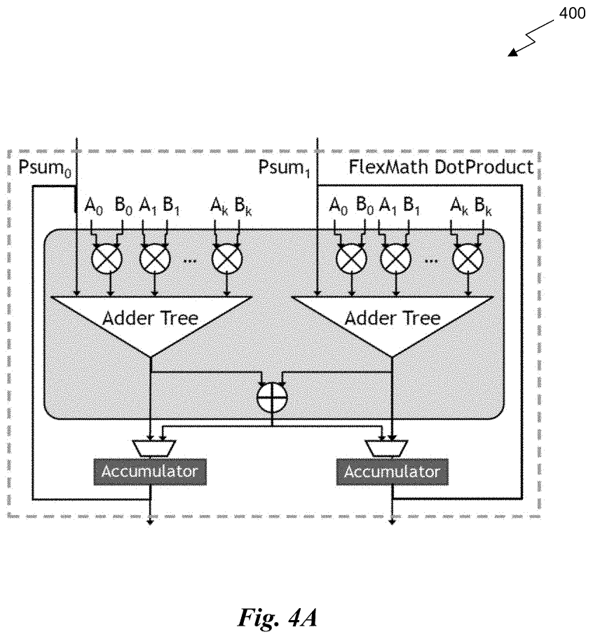

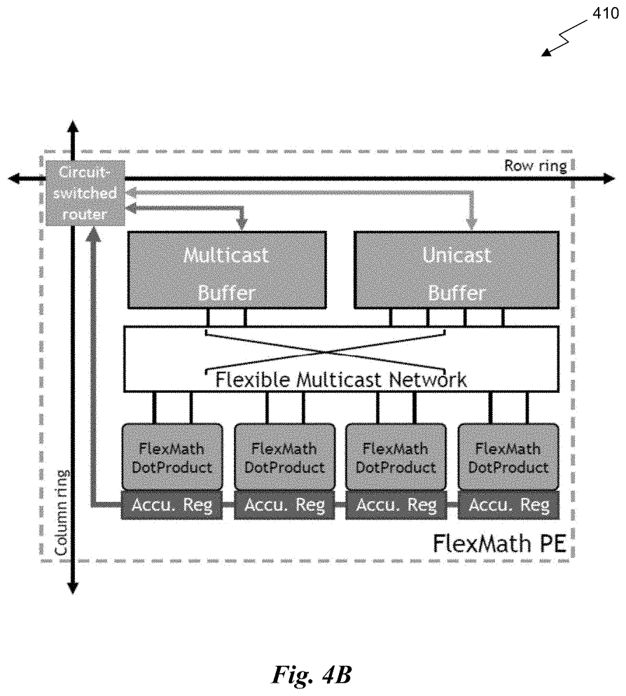

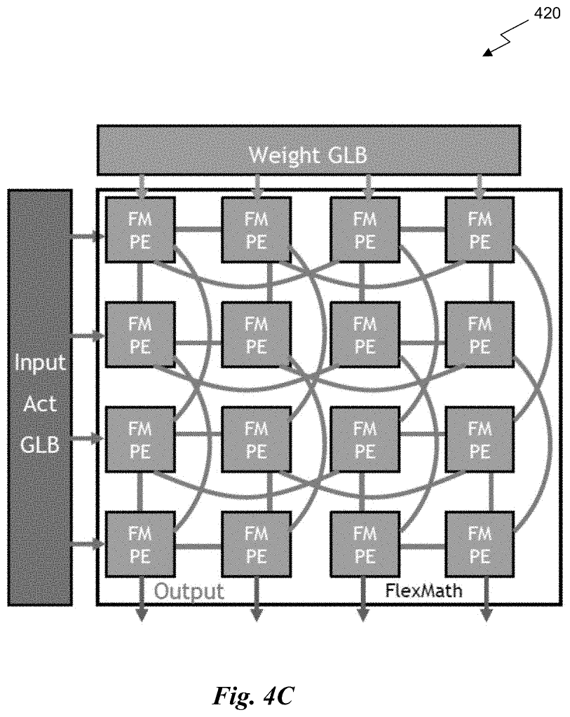

FIG. 4A illustrates a configurable datapath element 400 including a flexible dot product unit (DPU) with configurable dot product length, in accordance with an embodiment. The datapath element may be included in the datapath 301 layer of the hierarchical tensor accelerator architecture 300 of FIG. 3.

Starting at the datapath hierarchy level is a 1D tensor operation: a map-and-reduce operation (e.g. a dot product between two vectors). The map-and-reduce operation takes two 1D partial inputs and outputs a scalar partial result, which can be reused for additional computations. The tile shape of the 1D input tiles is the size of the reduction tree, which varies depending on the specific problem to be solved (e.g., depth-wise CONV has reduction size of 1). There are two axes at the datapath hierarchy level that can offer flexibility: map and reduce operation type and reduction operation size. The map operation can support a variety of operators (e.g. MAC, Min/Max, etc.) to enable a wider set of algorithmic domains, while variable reduction size can facilitate a variety of tile shapes.

The flexible tensor accelerator focuses on enabling a variety of tile shapes and implements a flexible dot product unit for the datapath hierarchy level. Dot product is the primitive reduction operation for many tensor operations across a variety of algorithmic domains, including GEMM and CONV. FIG. 4A shows the architecture of the dot product unit, which multiplies the two input data tiles element-wise before performing a reduction using the adder tree. Accumulation can occur by passing a scalar partial result as an input to the adder tree, and storing the scalar partial result into a small accumulator register file.

As shown, the flexible dot product unit can perform multiple dot products using separate adder trees and accumulator registers. Flexibility at the datapath level is enabled by combining the multiple dot products together, in effect increasing the length of the dot product operation with a single larger dot product unit. This configurability is enabled with additional adder tree stages to combine smaller reductions together, and multiplexer logic to select the correct dataflow. For example, when combining the adder trees together to create a larger dot product, only one accumulator input and output is needed, which is selected using the control logic.

In one exemplary embodiment, two 4-way reductions can easily be combined together into 8-way reductions using minimal logic and allowing better utilization. In another exemplary embodiment, supporting power-of-2 reduction widths may be sufficient, with no loss in utilization for real workloads. A smaller reduction tree (e.g., 2-way) may not be used because workloads which can leverage these small reduction trees are generally memory-bandwidth limited and do not benefit from such a fine granularity.

This flexibility allows the data path unit to be configured as logically various groups of dot-product unit and accumulators. For example, with the same number of multipliers and accumulators. In FIG. 4A, the hardware can be seen as a DP unit with length of 8 and accumulator size of 2. Or it can be seen as two groups of DP unit with length of 4 and accumulator size of 1. Therefore, the size of a set of logical accumulator is based on how the DP unit is configured.

FIG. 4B illustrates a configurable processing element (PE) 410 with buffers and DPUs connected via a flexible network, in accordance with an embodiment. The PE 410 may be included in the data supply 302 layer of the hierarchical tensor accelerator architecture 300 of FIG. 3.

The PE (data supply) hierarchy level adds another dimension to the tensor operation by introducing data buffers and multiple dot product units. This second dimension can be used in several ways to target different algorithms, leveraging the data buffers for data sharing across time and space. For example, 1D convolution can reuse input activations over time using a sliding window. Similarly, a general matrix-vector multiply (GEMV) can share a row vector across multiple dot product units, each with a different matrix column. The PE level employs two axes of flexibility. First, the buffers themselves enable data reuse, and therefore size of the buffer affects the opportunity for reuse over time. Second, the connectivity of the data buffers to the set of flexible dot product units enables additional data reuse via multicast.

Both buffer sizing and connectivity can be leveraged in building the flexible PE, as they are key for enabling alternative dataflows and tiles shapes. FIG. 4B shows the organization of the flexible PE, which has multiple (N) dot product units connected to two input operand buffers using a flexible multicast network. Each input buffer is designed to have a native entry width that matches the maximum 1D tile size (reduction size) of the dot product unit. The two operand buffers are designed to be asymmetric. One input buffer is highly-banked to have multiple read ports such that each dot product unit can receive a unique entry each cycle (primarily unicast). The other input buffer is less-banked and used primarily to multicast data to multiple dot product units.

Small address generators are configured to read from the input buffers using a set pattern for the desired tile shape and data flow. The flexible network supports limited connectivity to reduce complexity and target the desired patterns of GEMM and CONV tensor operations. The network can either be configured to: i) multicast a single 1D tile from one buffer, unicast N unique 1D tiles from the other buffer, enabling the PE to perform a GEMV operation per cycle; ii) grouped multicast to share two pairs of 1D tiles from two buffers; or iii) unicast four 1D tiles from both buffers to the dot product units. The multicast destination needs to be co-configured with the dot-product unit. The multicast buffer is also sized to capture the temporal sliding window reuse for 1D convolution. For example, a 1D convolution with Q=8, S=3, and C=8 needs 80 entries ((8+3−1)8). This buffer may be sized to capture the 1D sliding window for various filter sizes and striding pattern in CNN workloads and allow double buffering.

FIG. 4C illustrates a configurable inter-PE network 420 including a double folded torus network topology connecting PEs, in accordance with an embodiment. The inter-PE network 420 may be included in the inter-PE network 303 layer of the hierarchical tensor accelerator architecture 300 of FIG. 3.

The last level of the hierarchy is the inter-PE network connecting the set of PEs and the global buffer. This inter-PE network is how the flexible tensor accelerator enables more dataflows and hardware tile shapes than other accelerators. In an embodiment, higher-rank tensor operations can be implemented by composing by a set of lower-rank operations and capturing data reuse. For example, a GEMM accelerator can be implemented by composing multiple GEMV PEs that share the 2D input tiles across all PEs. A 2D CONV accelerator can be implemented by composing multiple 1D CONV PEs that share the input activations to exploit a 2D sliding window. The key axis of flexibility for the inter-PE network is the connectivity of the network to enable a variety of compositions.

In the present embodiment of FIG. 4C, the flexible tensor accelerator adopts sets of 1D peer-to-peer, ring networks that allow data exchanges between neighboring PEs. Together, the ring networks implement a 2D folded torus topology that balances complexity and connectivity. The network connects the global buffer banks to edge PEs. The network is configured at runtime and supports both store-and-forward multicast and peer-to-peer communication to allow different dataflows and tile shapes for GEMM and CONV. Multiple PEs can work together compute much larger 2D and 3D tensor operations. By dynamically configuring how to group 2-rank operation PEs into a multi-rank tensor accelerator, the flexible tensor accelerator supports configurable hardware tiles and operations with various dataflows, unlike prior accelerators that implement a fixed hardware tile with predesigned dataflows for particular tensor algorithms.

The 2D torus inter-PE network in the flexible tensor accelerator is able to support three different types of dataflows via flexible rings: store-and-forward multicast/reduction, skewed multicast/reduction, and sliding window reuse, as described in detail below.

This 2D torus network allows toroidal data movement between PEs to support various dataflow including (a) store-and-forward multicast and reduction across multiple PEs, (b) skewed/rotational multicast and reduction, (c) sliding window data reuse for 2D CONV AND (d) sliding window data reuse in for 3D CONV.

Supporting all pattern using one set of network is the novelty in the inter-PE network. There are prior systems does (a), (b), and (c). But none has done (d), and none has proposed one network to support all dataflows.

Store-and-Forward Multicast/Reduction

Store-and-forward dataflows on the flexible tensor accelerator leverage the inter-PE network as a uni-directional mesh. Operands and partial sums are passed from one PE to the next PE so that data is multicast or spatially reduced across multiple PEs over time. While store-and-forward dataflows have been adopted in prior art accelerators (e.g. the Tensor Processing Unit [TPU]'s systolic array passes input activations via store-and-forward in each row and reduces partial sums in each column), the flexible tensor accelerator of the present embodiment offers an unlimited range of store-and-forwarding using the expanded connectivity provided by the 2D torus topology. Thus, the flexible tensor accelerator is not limited to store-and-forward in only a single dimension across rows or columns of PEs, but instead can share operands across all PEs. This multi-dimensional support is especially useful when configuring the flexible tensor accelerator for efficient execution of irregular GEMM workloads, as described below.

Skewed Multicast/Reduction

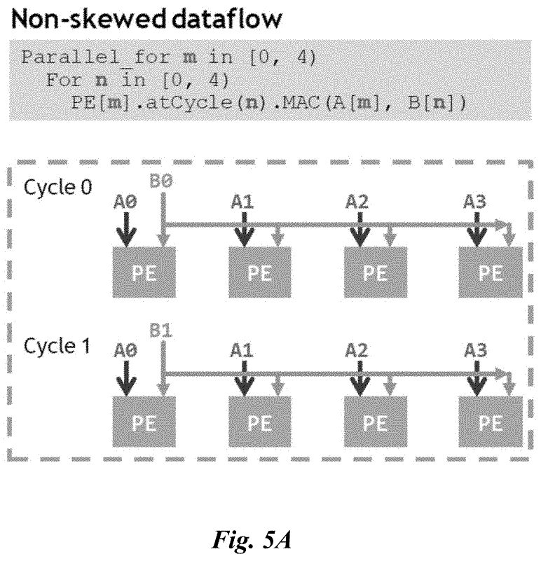

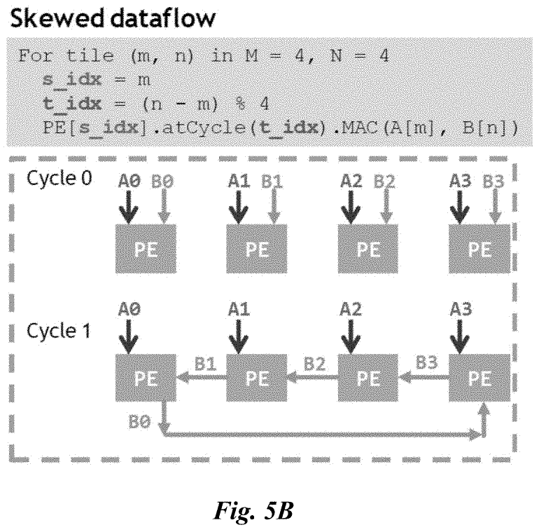

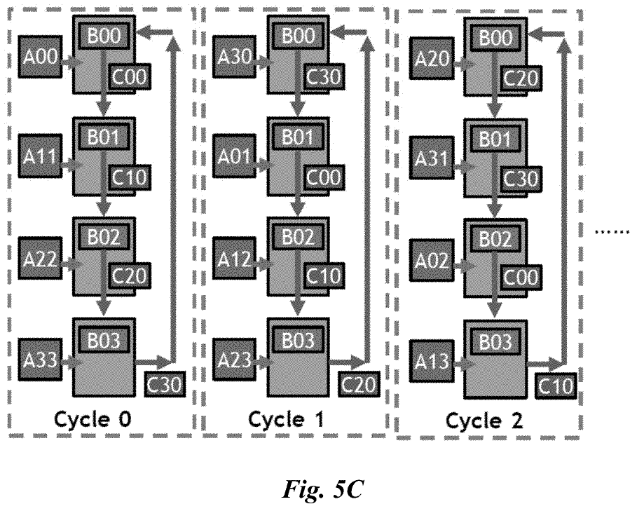

Skewed dataflows leverage peer-to-peer networks to exchange data between PEs over time for more efficient data reuse. FIG. 5A shows a non-skewed dataflow and FIG. 5B shows a skewed dataflow, which makes evident how each use different approaches to multicast B elements to four PEs over multiple cycles. In the non-skewed dataflow shown in FIG. 5A, each cycle a single B element is sent to the PEs via a fixed multicast network. In the skewed dataflow shown in FIG. 5B, each PE reads one B element in the first cycle. The B elements are then multicast across subsequent cycles via data exchanges between neighboring PEs. In both dataflows, A is kept stationary over four cycles, and the B elements are multicast to all four PEs. The key difference between the two dataflows is that skewed dataflows leverage one-to-one communication to accomplish multicast, which is more efficient than a fixed multicast network implementing one-to-many communication.

FIG. 5C illustrates how skewed dataflows can also be used in partial sum reductions. In this example B is kept stationary and in each cycle the four PEs receive new A elements that do not share rows/columns. Instead of storing the partial sum, the PEs pass the partial sum to their neighbor to be used as input and reduced in the next cycle. Over a full rotation of four cycles, four unique outputs are stored in each PE's accumulator.

These skewed dataflows generalize the Buffer Sharing Dataflow (BSD) in prior art, which only supports sharing operands and does not support reductions. Moreover, peer-to-peer data exchange and rotation in the 2D ring network of the flexible tensor accelerator is more efficient than the mesh network in Tangram due to the long distance between edge nodes.

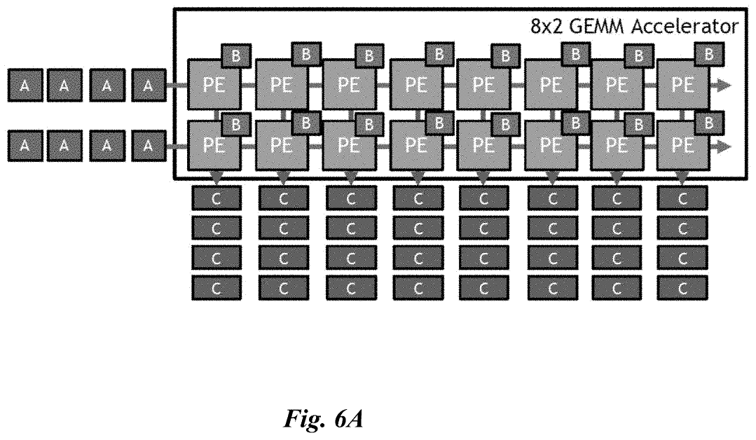

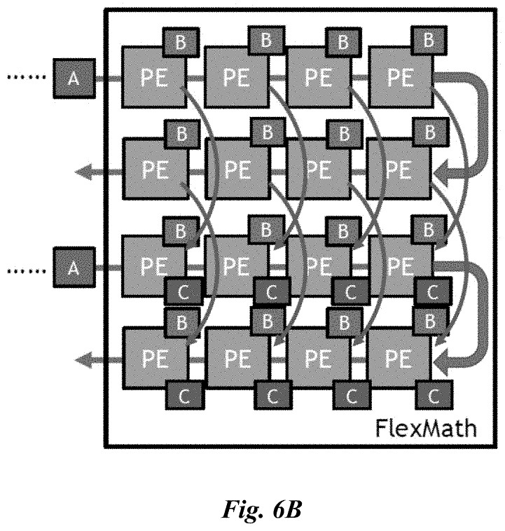

As mentioned above, the flexible tensor accelerator supports a variety of tensor algorithms having different tile shapes with different dataflows by leveraging flexibility in the data delivery networks. While the embodiments above describe how these networks can be configured to support a diverse set of dataflows, the embodiments of FIGS. 6A-B and 7A-C describe how those dataflows are used in different tensor workloads.

The Flexible Tensor Accelerator Configured as a GEMM Accelerator

Using the two dataflows described above, the flexible tensor accelerator can support diverse GEMM kernels. The PEs of the flexible tensor accelerator are first configured as GEMV PEs, and depending on the GEMM dimensional parameters, the full system is then configured to use different dataflows for different operands.

Configuring a Regular GEMM Accelerator

For regular (square tile shape) GEMMs, the flexible tensor accelerator adopts a weight-stationary dataflow. Different input activations are passed through the rows of PEs using a store-and-forward dataflow, and partial sums are reduced through the columns of PEs using a skewed reduction dataflow.

Configuring an Irregular GEMM Accelerator

For irregular GEMMs, the flexible tensor accelerator leverages the 2D torus connectivity to extend data sharing and mimic a non-square tile shape. The best accelerator design for an irregular GEMM workload matches the hardware dimensions with the workload dimension, as shown in FIG. 6A. FIG. 6B shows that the flexible tensor accelerator achieves this dataflow by folding the matrix on to the 2D torus network, such that two rows of four PEs effectively function as a single row of eight PEs. In this way, operand A (input activations) can be shared across more PEs via store-and-forward. The flexible tensor accelerator combines two sets of folded dataflows to create a two-way reduction, generating the output like a customized 8×2 PE array.

Some recently proposed prior art GEMM accelerators are also designed to support irregular GEMMs (e.g. by adopting an omni-directional systolic subarray and two sets of bidirectional ring buses to share input activations and partial sums across subarrays [small GEMM PEs]), however these accelerators use a 1D ring bus and only extend store-and-forward/reduction capability. The flexible tensor accelerator described herein, however, leverages the 2D torus to enable more dataflows and sharing patterns, as described above with respect to the various supported dataflows.

In the previous examples, a weight (B)-stationary dataflow was shown for illustration. It should be noted, however, that the flexible tensor accelerator can also be configured to use an input (A)-stationary dataflow by swapping the dataflow and network usage between weights and inputs.

The Flexible Tensor Accelerator Configured as a CONV Accelerator

The flexible tensor accelerator can also be configured as a CONV accelerator. The key difference between a GEMM accelerator and CONV accelerator is whether the accelerator can leverage the convolutional (i.e., sliding window) reuse in the input activations. The flexible tensor accelerator implements 2D CONV by first configuring each PE as a 1D CONV PE, connecting multiple PEs to compute a 2D convolution kernel. These PEs share data with neighbors to create a large monolithic math engine for 2D/3D convolution.

Configuring a Regular CONV Accelerator

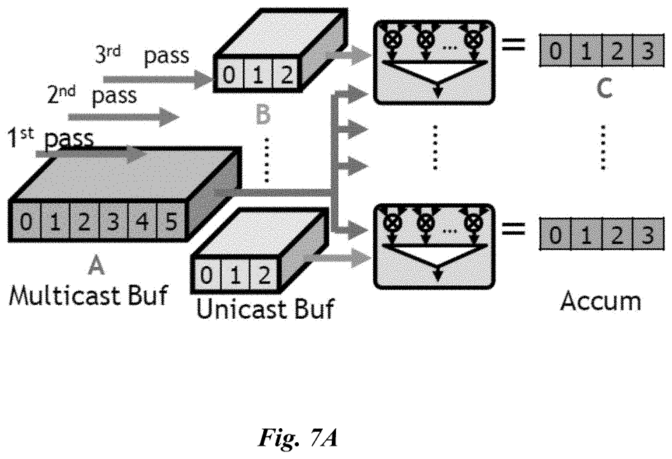

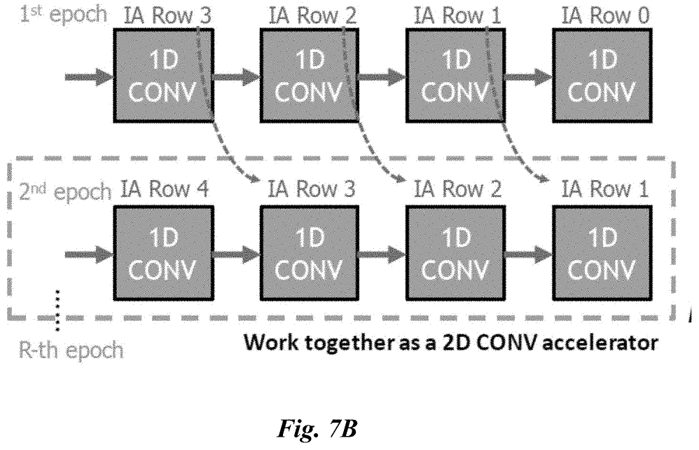

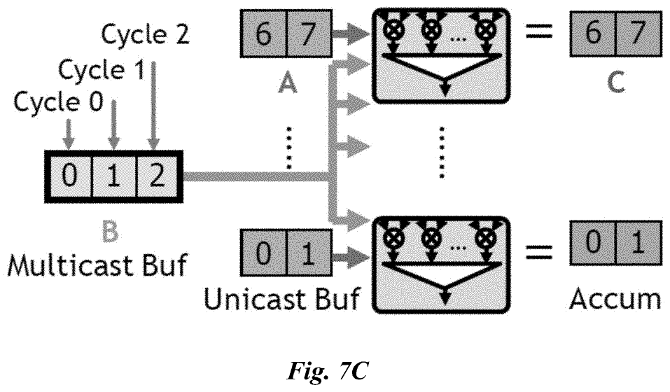

Similar to GEMM, the flexible tensor accelerator adapts a weight-stationary dataflow for regular CONV (square input/output channels). Each PE uses the multicast buffer to store a row of the input activation vectors, including the input halos, and uses the unicast buffer to store vectors of weights, as shown in FIG. 7A. For a 1D CONV with a filter width of 3, each flexible tensor accelerator PE will make three passes through the input activation buffer, exploiting the 1D sliding window reuse.

When all 1D CONV PEs are done with the current row (epoch), they leverage the cross PE ring to exchange the rows with their neighbors. FIG. 7B shows this dataflow. For a 2D convolution with filter height of 3, there will be three epochs to pass input activation rows around. This data exchange need not happen at the row granularity, as the PE can start exchanging element data before the current row is finished. For CONV kernels with stride greater than one, the flexible tensor accelerator simply discards rows with no sliding window reuse.

The flexible tensor accelerator can also support 3D CONV natively by extending the sliding window dataflow into the third dimension. Once a group of 1D CONV PEs are done with all epochs, they can pass the input activation plane to a nearby PE group, leveraging the sliding window in the other dimension.

Configuring an Irregular CONV Accelerator

Irregular CONV kernels like depth-wise CONV have much less data reuse than regular CONV. Therefore, to support these workloads, the flexible tensor accelerator swaps the buffer usage in each 1D CONV PE, as shown in FIG. 7C. Weights use the multicast buffer, while input activations use the unicast buffer. At each cycle, a single weight vector is multicast to all dot product units, and multiple input activation elements are read from the unicast buffer. For input channel size smaller than 8 (e.g. depth-wise convolution), FlexMath also splits the flexible dot product into two units to support the smaller reduction length.

For depth-wise convolution, the flexible tensor accelerator connects more 1D PEs than the width of the system. 16 rows of input activations can be folded on a 4×4 flexible tensor accelerator system, similar to how irregular GEMM is folded. This folding lets the flexible tensor accelerator exploit the sliding window data reuse in depth-wise convolution.

The sliding window dataflow using the flexible tensor accelerator's ring network is similar to some prior art CONV accelerators. However, the prior art assumes single-MAC PEs, while other prior art maps multiple filter rows, which often leads to lower utilization. Also, the way the flexible tensor accelerator passes rows between PEs to accumulate the partial sum into the accumulator generalizes the inter PE propagation dataflow of the prior art. The flexible tensor accelerator is more flexible in the output dimensions it can support as the width is determined by the size of PE buffer, and the height can be adapted using the 2D torus network. Moreover, the flexible tensor accelerator supports 3D CONV natively, while the prior art cannot. This is because each PE has local sliding window reuse for 1D CONV, and the 2D torus network further extend the dimension of convolution into 2D and 3D CONV.

Configuring the Flexible Tensor Accelerator for Other Tensor Workloads

The flexible tensor accelerator can be configured to support other tensor workloads, such as those that can be composed of 1- and 2-rank operations. The best mapping and configuration depend on the workload parameters, to which the flexible tensor accelerator can be adapted. While the mapping for the targeted workload can be manually created using the flexibility in the flexible tensor accelerator, automatic mapping search tools such can also be used to search for the best mappings on complex tensor algorithms.

### CONCLUSION

Tensor algorithms adopt a diverse set of tensor operations. However, state-of-the-art tensor accelerators are designed to execute fixed-size tile of tensor operations, either GEMM or CONV, most efficiently. Any mismatch between the algorithm and the native (tensor accelerator) hardware tile leads to inefficiency, such as unnecessary data movement or low utilization. The embodiments described above provide a flexible tensor accelerator which leverages a hierarchy of configurable data delivery network to provide flexible data sharing capability for diverse tensor workloads. The flexible tensor accelerator executes both GEMM and CONV efficiently and increases accelerator utilization for irregular tensor operations. As a result, the flexible tensor accelerator improves end-to-end NN latency over a fixed-tile, rigid GEMM accelerator, and is more energy and area efficient than a rigid CONV accelerator.

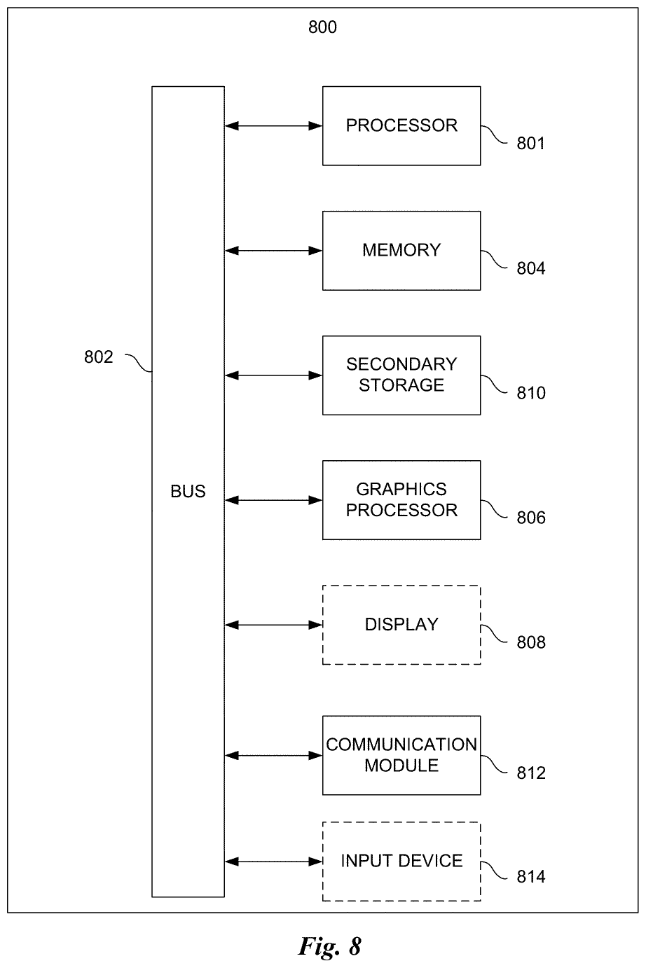

FIG. 8 illustrates an exemplary system 800, in accordance with one embodiment. As an option, the system 800 may be implemented to carry out any of the methods, processes, operations, etc. described in the embodiments above. As an option, the system 800 may be implemented in a data center to carry out any of the embodiments described above in the cloud.

As shown, a system 800 is provided including at least one central processor 801 which is connected to a communication bus 802. The system 800 also includes main memory 804 [e.g. random access memory (RAM), etc.]. The system 800 also includes a graphics processor 806, and optionally includes a display 808.

The system 800 may also include a secondary storage 810. The secondary storage 810 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 804, the secondary storage 810, and/or any other memory, for that matter. Such computer programs, when executed, enable the system 800 to perform various functions (as set forth above, for example). Memory 804, storage 810 and/or any other storage are possible examples of non-transitory computer-readable media.

The system 800 may also include one or more communication modules 812. The communication module 812 may be operable to facilitate communication between the system 800 and one or more networks, and/or with one or more devices through a variety of possible standard or proprietary communication protocols (e.g. via Bluetooth, Near Field Communication (NFC), Cellular communication, etc.).

As also shown, the system 800 may also optionally include one or more input devices 814. The input devices 814 may be wired or wireless input device. In various embodiments, each input device 814 may include a keyboard, touch pad, touch screen, game controller (e.g. to a game console), remote controller (e.g. to a set-top box or television), or any other device capable of being used by a user to provide input to the system 800.

What is claimed is:

1. A method for configuring a flexible dot product unit (DPU), comprising:
at a device:
determining a target compute throughput for the flexible DPU which is less than or equal to a maximum throughput of the flexible DPU; and
configuring one or more logical groups of dot product sub-units and corresponding sub-accumulators, wherein a dot product length of each of the dot product sub-units is configured based on the target compute throughput.

2. The method of claim 1, wherein each logical group of the one or more logical groups includes a dot product sub-unit and a corresponding sub-accumulator.

3. The method of claim 1, wherein the dot product length of each of the dot product sub-units, when combined, achieves the target compute throughput.

4. The method of claim 3, wherein the dot product sub-units are configured with a same dot product length.

5. A method for configuring a flexible tensor accelerator, comprising:
identifying one or more properties of a tensor workload; and
dynamically configuring one or more elements of a tensor accelerator, based on the one or more properties of the tensor workload, including at least dynamically configuring a flexible dot product unit (DPU) by:
determining a target compute throughput for the flexible DPU which is less than or equal to a maximum throughput of the flexible DPU, and
configuring one or more logical groups of dot product sub-units and corresponding sub-accumulators, wherein a dot product length of each of the dot product sub-units is configured based on the target compute throughput.

6. The method of claim 5, wherein each logical group of the one or more logical groups includes a dot product sub-unit and a corresponding sub-accumulator.

7. The method of claim 5, wherein the dot product length of each of the dot product sub-units, when combined, achieves the target compute throughput.

8. The method of claim 7, wherein the dot product sub-units are configured with a same dot product length.

9. The method of claim 5, wherein a configuration of the flexible DPU corresponds to a shape of an input and an output of the tensor workload.

10. The method of claim 5, wherein the tensor workload is a workload of a tensor algorithm.

11. The method of claim 10, wherein the tensor algorithm is a General Matrix Multiply (GEMM) algorithm.

12. The method of claim 10, wherein the tensor algorithm is one of:
a one-dimensional (1D) convolutional neural network (CNN) algorithm,
a two-dimensional (2D) CNN algorithm, or
a three-dimensional (3D) CNN algorithm.

13. The method of claim 5, wherein the one or more elements of the tensor accelerator are dynamically configured at runtime.

14. The method of claim 5, wherein the one or more elements of the tensor accelerator are included in one or more hierarchical layers of the tensor accelerator, and including dynamically configuring at least one of:
buffers,
an on-chip network, or
datapath element connections.

15. The method of claim 5, wherein the one or more elements of the tensor accelerator include datapath elements of the tensor accelerator having one or more functional units, wherein the datapath elements include the flexible DPU.

16. The method of claim 5, wherein the one or more elements of the tensor accelerator include processing elements of the tensor accelerator having buffers and datapath element connections between datapath elements of the tensor accelerator.

17. The method of claim 16, wherein the buffers and datapath element connections are configured based on the one or more properties of the tensor workload by:
configuring the buffers and datapath element connections to enable data reuse.

18. The method of claim 5, wherein the one or more elements of the tensor accelerator include an inter-PE network of the tensor accelerator having a global buffer and processing element connections between processing elements of the tensor accelerator.

19. The method of claim 18, wherein the global buffer and processing element connections are configured based on the one or more properties of the tensor workload by:
configuring the global buffer and processing element connections to support the one or more properties of the tensor workload.

20. The method of claim 5, wherein the flexible tensor accelerator is implemented with a single instruction, multiple data (SIMD) execution engine.

21. The method of claim 5, wherein the flexible tensor accelerator is implemented with an ADX (Multi-Precision Add-Carry Instruction Extensions) instruction.

22. A non-transitory computer-readable media storing computer instructions for configuring a flexible tensor accelerator that, when executed by one or more processors of a device, cause the device to:
identify one or more properties of a tensor workload; and
dynamically configure one or more elements of a tensor accelerator, based on the one or more properties of the tensor workload, including at least dynamically configuring a flexible dot product unit (DPU) by:
determining a target compute throughput for the flexible DPU which is less than or equal to a maximum throughput of the flexible DPU, and
configuring one or more logical groups of dot product sub-units and corresponding sub-accumulators, wherein a dot product length of each of the dot product sub-units is configured based on the target compute throughput.

23. The non-transitory computer-readable media of claim 22, wherein each logical group of the one or more logical groups includes a dot product sub-unit and a corresponding sub-accumulator.

24. The non-transitory computer-readable media of claim 22, wherein the dot product length of each of the dot product sub-units, when combined, achieves the target compute throughput.

25. The non-transitory computer-readable media of claim 24, wherein the dot product sub-units are configured with a same dot product length.

26. The non-transitory computer-readable media of claim 22, wherein a configuration of the flexible DPU corresponds to a shape of an input and an output of the tensor workload.

27. The non-transitory computer-readable media of claim 22, wherein the tensor workload is a workload of a tensor algorithm.

28. The non-transitory computer-readable media of claim 27, wherein the tensor algorithm is a General Matrix Multiply (GEMM) algorithm.

29. The non-transitory computer-readable media of claim 27, wherein the tensor algorithm is one of:
a one-dimensional (1D) convolutional neural network (CNN) algorithm,
a two-dimensional (2D) CNN algorithm, or
a three-dimensional (3D) CNN algorithm.

30. A flexible tensor accelerator, comprising:
one or more tensor accelerator elements that are dynamically configurable to support one or more properties of a tensor workload, the one or more tensor accelerator elements including at least a flexible dot product unit (DPU) having configurable logical groupings of dot product sub-units and corresponding sub-accumulators, wherein a dot product length of each of the dot product sub-units is configurable based on a target compute throughput for the flexible DPU which is less than or equal to a maximum throughput of the flexible DPU.

31. The flexible tensor accelerator of claim 30, wherein each logical grouping of the one or more logical grouping includes a dot product sub-unit and a corresponding sub-accumulator.

32. The flexible tensor accelerator of claim 30, wherein the dot product length of each of the dot product sub-units is configurable such that, when combined, the target compute throughput is achieved.

33. The flexible tensor accelerator of claim 32, wherein the dot product sub-units are configurable to have a same dot product length.

34. The flexible tensor accelerator of claim 30, wherein a configuration of the flexible DPU corresponds to a shape of an input and an output of the tensor workload.

35. The flexible tensor accelerator of claim 30, wherein the one or more tensor accelerator elements include datapath elements having one or more functional units, wherein the datapath elements include the flexible DPU.

36. The flexible tensor accelerator of claim 30, wherein the one or more tensor accelerator elements include processing elements having buffers and datapath element connections between datapath elements.

37. The flexible tensor accelerator of claim 36, wherein the buffers and datapath element connections are dynamically configurable to enable data reuse.

38. The flexible tensor accelerator of claim 30, wherein the one or more tensor accelerator elements include an inter-PE network having a global buffer and processing element connections between processing elements.

39. The flexible tensor accelerator of claim 38, wherein the global buffer and processing element connections are dynamically configurable to support the one or more properties of the tensor workload.

40. A flexible field-programmable gate array (FPGA), comprising:
one or more FPGA elements that are dynamically configurable to support one or more properties of tensor workload, the one or more FPGA elements including at least a flexible dot product unit (DPU) having configurable logical groupings of dot product sub-units and corresponding sub-accumulators, wherein a dot product length of each of the dot product sub-units is configurable based on a target compute throughput for the flexible DPU which is less than or equal to a maximum throughput of the flexible DPU.

41. The flexible tensor accelerator of claim 40, wherein each logical grouping of the one or more logical grouping includes a dot product sub-unit and a corresponding sub-accumulator.

42. The flexible tensor accelerator of claim 40, wherein the dot product length of each of the dot product sub-units is configurable such that, when combined, the target compute throughput is achieved.

43. The flexible tensor accelerator of claim 42, wherein the dot product sub-units are configurable to have a same dot product length.

44. The flexible tensor accelerator of claim 40, wherein a configuration of the flexible DPU corresponds to a shape of an input and an output of the tensor workload.

45. The flexible FPGA of claim 40, wherein the one or more FPGA elements include FPGA hardware blocks.

46. The flexible FPGA of claim 40, wherein connections between the one or more configurable FPGA elements are dynamically configurable.
